(19) United States
(12) Patent Application Publication
(10) Pub. No.: US 2006/0190172 A1
(43) Pub. Date: Aug. 24, 2006

(54) GPS device and method for layered display of elements

(76) Inventors: John Cross, Overland Park, KS (US); Christopher Lalik, Overland Park, KS (US); John DeCastro, Lenexa, KS (US); Richard Ball, Overland Park, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/065,541

(22) Filed: Feb. 24, 2005

(51) Int. Cl. G01S 1/00

(52) U.S. Cl. 701/213; 342/357.06

(57) ABSTRACT

A GPS device and method for conditioning and hierarchically layering or ordering a plurality of static or dynamic image, information, tool, control, or other elements for simultaneous display in such a way as to minimize interference and maximize total benefit from and usability of the various elements.

### BACKGROUND OF THE INVENTION

1. Field of the Invention

The present invention relates broadly to hand-held electronic GPS-based navigation aids and related methods for facilitating navigation. More particularly, the present invention concerns a GPS device and method for conditioning and hierarchically layering or ordering a plurality of static or dynamic image, information, tool, control, or other elements for simultaneous display in such a way as to minimize interference and maximize total benefit from and usability of the various elements.

2. Description of the Prior Art

Outdoor enthusiasts, such as sportsmen, vacationers, and athletes, increasingly use hand-held electronic global positioning system (GPS) devices to navigate while afield. Commonly-available GPS devices typically include at least a processor, a receiver, and an antenna for receiving position signals from a plurality of known locations (e.g., from satellites in orbit) and, through a process of geometric triangulation, determining the relative location of the GPS device in terms of latitude, longitude, and even altitude. Many such devices allow users to separately display a variety of different types of maps or other images, with each such image containing some particular perspective or other information that the user may desire or need. For example, the user may be able to separately display a topographical map and a street map of the same geographic area. Unfortunately, these different maps are not simultaneously viewable by the user. Instead, the user must toggle the display from one map to the other, or otherwise separately display the maps, which can both cause disorientation and create an artificial disconnect that reduces the user's appreciation of the total information content of the maps.

Relatedly, some such prior art GPS devices allow users to create and display waypoints, paths, or other geo-referenced information in association with a particular map or other image. Unfortunately, when the user toggles to a different map or image the geo-referenced information does not follow. At best, the user may be able to display a separate instance of the geo-referenced information in association with each map or other image which the user desires to view, which introduces a substantial degree of inconvenience and inefficiency.

Additionally, some such prior art GPS devices require considerable user interaction to set-up or otherwise prepare for use, including creating the aforementioned geo-referenced information. Often a veritable maze of menus and screens must be navigated in order to get to the particular menu or screen needed for a desired operation, and, once finished, the user must navigate back through the menus in order to return to and continue a previous activity. This process can be very time consuming and even intimidating.

Due to these and other disadvantages in the prior art, a need exists for a GPS device capable of more usefully displaying multiple elements, and thereby enable safer and more efficient navigation while in the field.

### SUMMARY OF THE INVENTION

The present invention overcomes the above-described and other disadvantages in the prior art by providing a GPS device and method for conditioning and hierarchically layering or ordering a plurality of static or dynamic image, information, tool, control, or other elements for simultaneous display in such a way as to minimize interference and maximize total benefit from and usability of the various elements.

The image elements may include photographs, maps, or other images; the information elements may include geo-referenced information such as waypoints and past and future paths or trails; the tool elements may include virtual compasses, direction finders, direction indicators, clocks, and timers; and the control elements may include virtual buttons, switches, selectable symbols, and menus. All such elements may be static or dynamic in nature. Whenever two or more elements are simultaneously displayed, they are layered in accordance with a display hierarchy which minimizes interference between the elements. In a preferred hierarchical layering or ordering scheme, control elements are generally moved to the topmost layer; tool elements may be displayed either on the same layer as the control elements or one layer below the control elements; geo-referenced information elements may be displayed one layer below the tools; image elements with limited information content may be displayed on the layer(s) below the geo-referenced information, and such image elements may be conditioned by making unimportant portions transparent or semi-transparent to further reduce interference; and images elements with large amounts of information content, such as, for example, aerial photographs, may be displayed on the lowest layer(s) as they would otherwise likely interfere too greatly with images on even deeper layers. Such conditioning and hierarchical layering or ordering allows multiple dynamic elements to be simultaneously displayed while retaining independent functionality.

The GPS device includes one or more mechanical or virtual buttons, actuation of which results in direct access to and causes to be displayed a particular menu element, which, as mentioned, is placed in the topmost layer. The menu selections can be made and the menu element closed without interrupting any dynamic activity, such as updating, occurring in other elements or on other layers.

Thus, it will be appreciated that the GPS device and method of the present invention provides a number of substantial advantages over the prior art, including, for example, allowing for simultaneously displaying substantially any combination of image, information, tool, control or other elements while minimizing interference and maximizing total benefit from and usability of the various elements. Furthermore, the direct-access menu buttons allow for directly accessing and displaying particular menus without having to navigate through higher-level menus.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a block-diagram depiction of a preferred embodiment of a GPS device of the present invention;

FIG. 2 is a depiction of a topographical map showing elevation or contour lines, wherein the topographical map is displayed on the GPS device of FIG. 1 simultaneously with and under geo-referenced information in the form of a waypoint and a trail;

FIG. 3 is a depiction of a street map displayed simultaneously with and over the topographical map of FIG. 2;

FIG. 4 is a depiction of an aerial photograph displayed simultaneously with and under both the topographical map of FIG. 2 and the street map of FIG. 3;

FIG. 5 is a depiction of a virtual compass displayed simultaneously with and over all of the topographical map of FIG. 2, the street map of FIG. 3, and the aerial photograph of FIG. 4;

FIG. 6 is a depiction of a virtual menu displayed simultaneously with and on the same layer as the virtual compass of FIG. 5 and over all of the topographical map of FIG. 2, the street map of FIG. 3, and the aerial photograph of FIG. 4; and

FIG. 7 is a flowchart of steps involved in operation of the GPS device of FIG. 1.

### DETAILED DESCRIPTION OF THE PREFERRED EMBODIMENT(S)

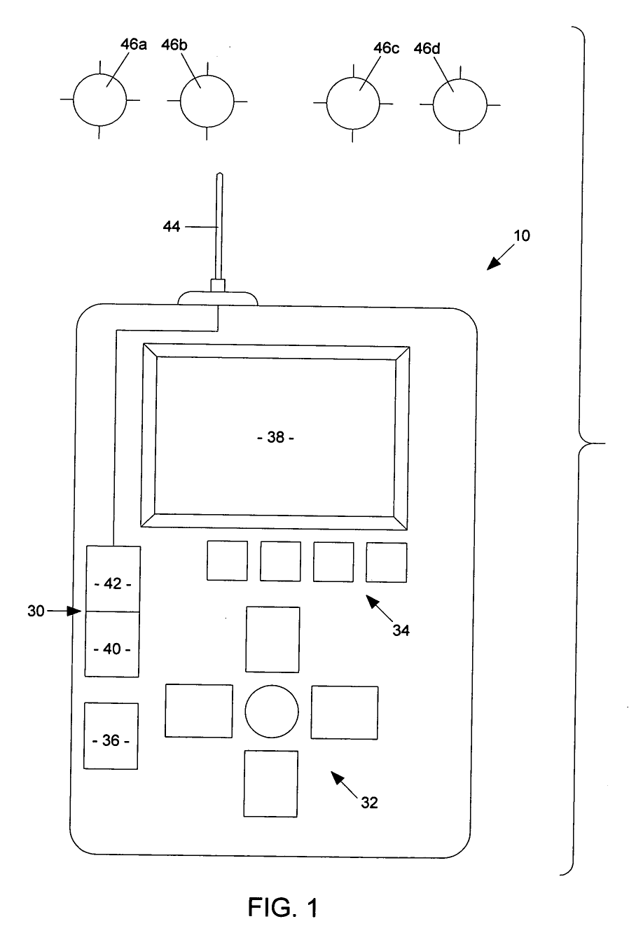

With reference to the figures, a GPS device 10 and method are herein described, shown, and otherwise disclosed in accordance with the preferred embodiment(s) of the present invention. More specifically, referring to FIG. 1, the present invention concerns conditioning and hierarchically layering or ordering a plurality of static or dynamic image, information, tool, control, or other elements for simultaneous display in such a way as to minimize interference and maximize total benefit from and usability of the various elements.

The image elements may include photographs, maps, or other images, such as, for example, aerial photographs, perspective photographs, topographical maps, satellite images, weather images, and Doppler radar images. The information elements may include geo-referenced information such as waypoints, past and future paths or trails, and meaningful symbols or other virtual devices corresponding to natural or artificial structures or phenomena. These elements may be static or dynamic, as appropriate. A street map might, for example, be displayed as a static image, though the user may be able to “move” the image in a desired direction by periodically causing the image of a particular area to be replaced by an image of an adjacent area in the direction of the user's travel. Contrastingly, a weather image might, for example, be displayed as a dynamic image with clouds or other weather structures of interest shown moving along their particular tracks, which might be accomplished by frequently automatically updating the image in order to impart the appearance of natural movement.

The tool elements may include virtual compasses, direction finders, direction indicators, clocks, timers, and other similarly useful virtual tools. These elements may also be static or dynamic, as appropriate. More specifically, some such tools, such as compasses, are most appropriately dynamic in nature, while other tools, such as direction indicators, could be made static such that a user must actively refresh or otherwise reset the tool in order for it to update and accurately reflect current conditions.

The control elements may include virtual buttons, switches, selectable symbols, menus, and other similarly useful controls. These elements may also be static or dynamic, as appropriate. More specifically, most such controls will likely be static, though some may be dynamic and depend on some changing aspect such as the location of the user or of an object in the environment.

Whenever two or more of any such elements or combination of elements are simultaneously displayed, they are ordered in accordance with a pre-established hierarchy which minimizes interference between the elements. In a preferred hierarchical layering or ordering scheme, for example, control elements are generally moved to a topmost layer or level, i.e., over or above all other elements because any interference from other elements might impair the user's ability to use the controls. Tool elements may be displayed either on the same layer as the control elements, i.e., adjacent to them, or one layer below the control elements. Again, this is because the tool elements are easiest to use when there is a minimum of visual interference. All geo-referenced information such as waypoints, paths and trails, and symbols may be displayed one layer below the tools. Maps or other images with limited information content and therefore minimum interference may be displayed on the layer(s) below the geo-referenced information. Unimportant portions of such maps or other images may be made transparent or semi-transparent to further reduce interference. For example, the only important information in an elevation map may be the actual contour lines, and therefore the remainder of the map may be made transparent so that only the contour lines remain to visually interfere with the viewing of elements on deeper layers. Maps or other images with large amounts of information content, such as, for example, aerial photographs, may be displayed on the lowest layer(s). Such images generally have little or no few unimportant portions which could be made transparent or semi-transparent without losing desirable information, and would therefore interfere too greatly with images on deeper layers.

Furthermore, such conditioning and hierarchical layering or ordering allows multiple dynamic elements to be simultaneously displayed while retaining independent functionality. For example, a dynamic compass element might be displayed with a dynamic image element, and each would continue with its dynamic activity without substantial interference from the other. This is an extremely advantageous improvement over the prior art in which such elements could not be simultaneously displayed, forcing the user to toggle between displays. In another example, a menu element might be displayed with a dynamic image element. Preferably, some or all such menu elements are directly accessible by depressing or selecting a corresponding mechanical or virtual button, which causes the menu element to be displayed over all other elements. The menu selections can be made and the menu element closed without interrupting any dynamic activity, such as updating, occurring in other elements or on other layers. This is also an extremely advantageous improvement over the prior art in which using such menu elements required navigating a veritable maze of menus, making selections, and then navigating back to the other elements which, during this period, were not regularly updated. A plurality of such menu buttons may be provided, with each corresponding to and allowing for directly accessing a different menu, thereby eliminating the need to navigate through higher-level menus in order to access and display more specific menus.

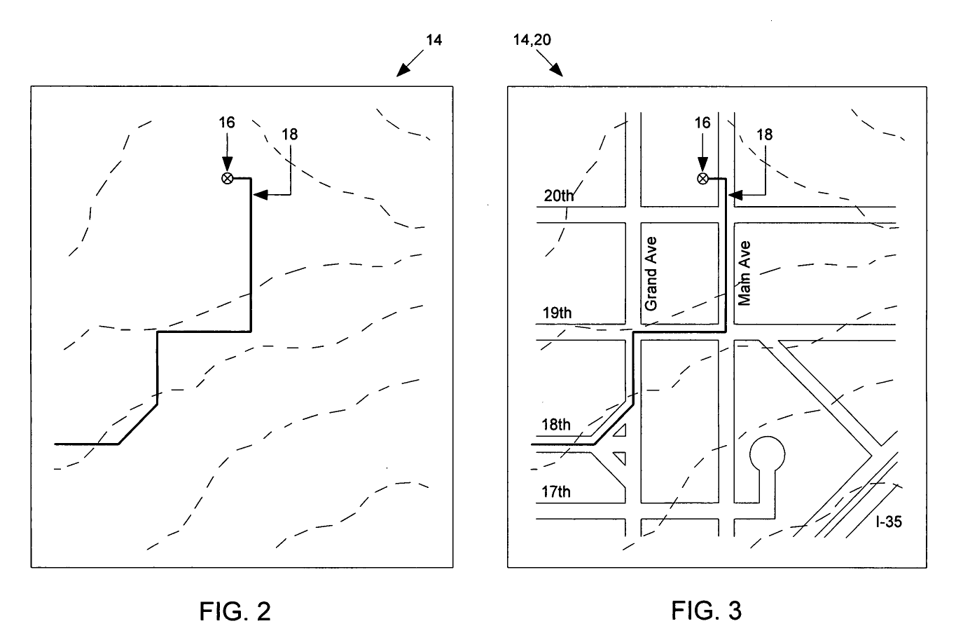

FIGS. 2-6 illustrate the conditioning and hierarchical layering or ordering of various elements and their simultaneous display in accordance with the present invention. FIG. 2 shows a topographical map 14 which communicates changes in the elevation of the land. FIG. 2 also shows geo-referenced information in the form of a waypoint 16 and a trail 18 simultaneously displayed with and over the topographical map 14. FIG. 3 shows the topographical map 14 simultaneously displayed with a street map 20 which communicates streets and street names. In the display hierarchy, the street map 20 is displayed over the topographical map 14 so as to minimize interference between the two maps and allow the user to better appreciate the information communicated by each map. The street map 20 is conditioned prior to display in order to further minimize interference. Such conditioning may include, for example, making certain unimportant or less important portions of the street map 20 transparent or semi-transparent so that the underlying topographical map 14 is more or better visible. Also in the display hierarchy, the geo-referenced information is now displayed over both the topographical map 14 and the street map 20, i.e., in the highest current layer.

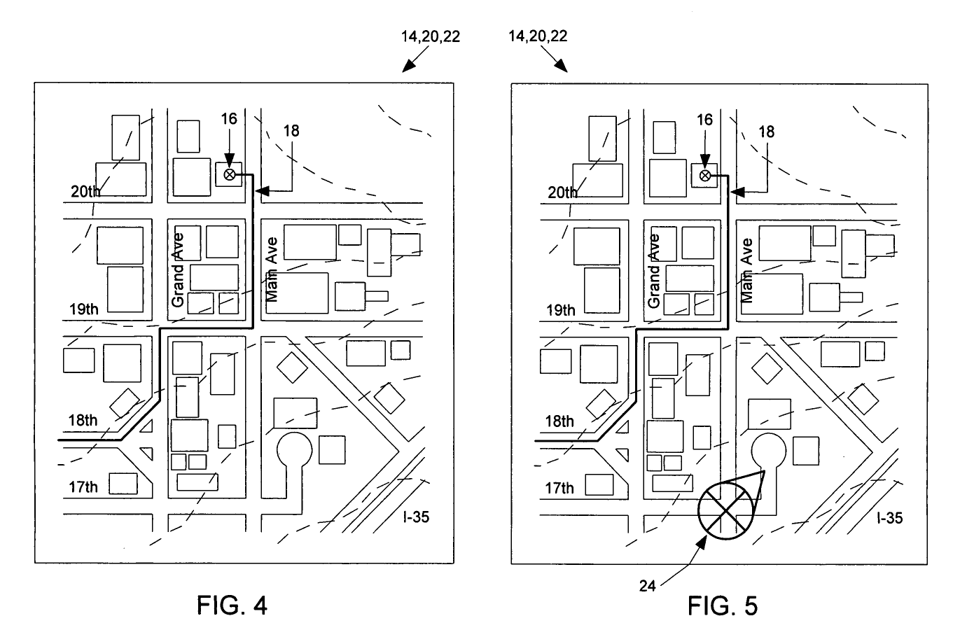

FIG. 4 shows the topographical map 14, the street map 20, and the geo-referenced information simultaneously displayed with an aerial photograph 22. In the display hierarchy, because the aerial photograph 22 contains the most information and is least amenable to being made even semi-transparent, the aerial photograph 22 is displayed on the lowest level beneath all other elements.

FIG. 5 shows the preceding four elements 14, 16 and 18, 20, and 22 simultaneously displayed with a virtual compass 24. In the display hierarchy, the virtual compass 24 is most appropriately displayed over all of the preceding elements, i.e., on the highest current layer.

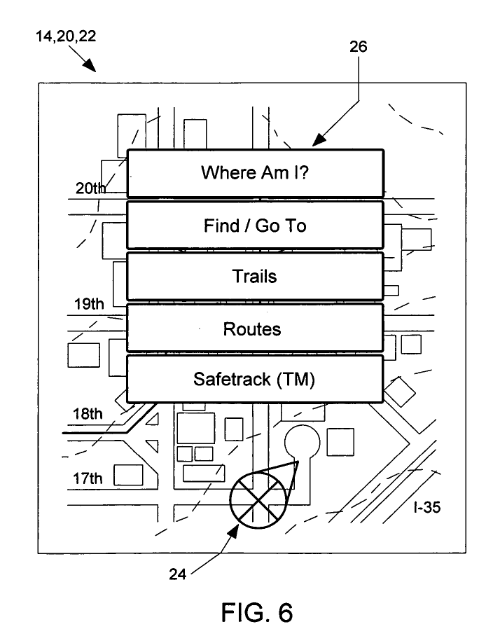

FIG. 6 shows the preceding five elements 14, 16 and 18 (covered), 20, 22, and 24 simultaneously displayed with a virtual menu 26. In the display hierarchy, the virtual menu 26 is most appropriately displayed over all other elements except perhaps any tools which can be displayed on the same layer without interfering with the virtual menu 26. As such, the virtual menu 26 is shown displayed adjacent to and on the same layer as the virtual compass 24.

Referring again to FIG. 1, a preferred embodiment of the GPS device 10 broadly comprises a GPS unit 30; an input interface 32, including one or more menu buttons 34; a processor 36; and an output display 38. It will be appreciated that devices using GPS technology for determining location are well-known to those with ordinary skill in the art, and therefore the present disclosure focuses primarily on the claimed features that comprise the present invention, rather than on said basic technology. The GPS device 10 as a whole is appropriately designed and constructed so as to be lightweight, rugged, waterproof, and otherwise resistant to relatively harsh environments and operating conditions.

The GPS unit 30 includes at least a processor 40, a receiver 42, and an antenna 44 for, in a conventional manner, receiving position signals from a plurality of known locations 46a,46b,46c,46d (from, e.g., satellites in orbit) and, through a process of geometric triangulation, determining the relative location of the GPS unit 30.

The input interface 32 allows the user to enter information when prompted or otherwise as appropriate, including indicating desired elements to display. As such, the input interface 32 may take any appropriate form and use any available input technology such as, for example, keypad, touch-screen, or scroll-wheel technologies. The menu buttons 34 allow the user to, as earlier discussed, directly access and cause to be displayed corresponding menu elements.

The processor 36 appropriately conditions and hierarchically orders the elements selected for display in the manner earlier discussed so as to minimize interference and maximize total benefit from and usability of the various elements.

The output display 38 allows the GPS device 10 to communicate with the user, including presenting selections and/or prompting the user to make a selection, and to display the desired elements. As such, the output display 38 may take any appropriate form and use any available technology such as, for example, liquid crystal display (LCD) technology.

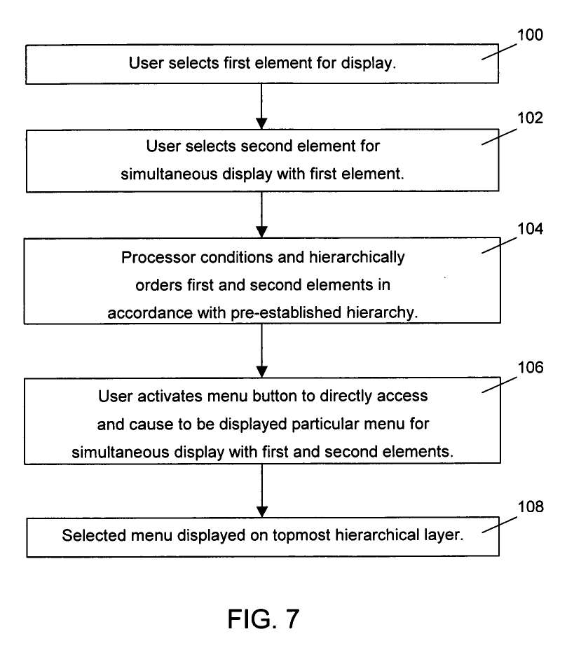

Referring to FIG. 7, in contemplated exemplary but non-limiting use and operation, the present invention may be characterized as functioning in accordance with the following steps. The user selects a first element for display, as shown in box 100. The user then selects a second element for simultaneous display with the first element, as depicted in box 102. The processor appropriately conditions and hierarchically orders the first and second elements and simultaneously displays them ordered in accordance with a pre-established hierarchy so as to minimize interference, as depicted in box 104.

The user then depresses, selects, or otherwise activates a direct-access menu button to cause a particular menu element to be displayed, as depicted in box 106. The processor locates the desired menu element on the topmost hierarchical layer, above the first and second elements, as depicted in box 108. Dynamic activity occurring on other layers or in other elements is substantially unaffected by the display and use of the menu.

From the preceding discussion it will be appreciated that the GPS device and method of the present invention provides a number of substantial advantages over the prior art, including, for example, allowing for simultaneously displaying substantially any combination of image, information, tool, control, or other elements while minimizing interference and maximizing total benefit from and usability of the various elements. Furthermore, the direct-access menu buttons allow for directly accessing and displaying particular menus without having to navigate through higher-level menus.

Although the invention has been described with reference to the preferred embodiments illustrated in the attached drawings, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A method for simultaneously displaying two or more elements on a GPS device, the method comprising the steps of:
(a) allowing a user to select the two or more elements for display;
(b) ordering the elements hierarchically in accordance with a pre-established hierarchy for minimizing interference between the elements; and
(c) displaying the hierarchically ordered elements simultaneously.

2. The method as set forth in claim 1, wherein at least one of the elements is an image element selected from the group consisting of: aerial photographs, perspective photographs, topographical maps, satellite images, weather images, and Doppler radar images.

3. The method as set forth in claim 1, wherein at least one of the elements is an information element selected from the group consisting of: geo-referenced waypoints, geo-referenced trails, geo-referenced paths, and geo-referenced symbols.

4. The method as set forth in claim 1, wherein at least one of the elements is a tool element selected from the group consisting of: virtual compasses, direction finders, direction indicators, clocks, and timers.

5. The method as set forth in claim 1, wherein at least one of the elements is a control element selected from the group consisting of: virtual buttons, virtual switches, symbols, and menus.

6. The method as set forth in claim 1, wherein at least one of the elements is dynamic, and wherein the at least one dynamic element functions without substantial interference from any other simultaneously displayed element.

7. The method as set forth in claim 1, wherein the pre-established hierarchy includes locating any control elements in a topmost layer and locating any image elements in one or more lower layers.

8. The method as set forth in claim 7, wherein the pre-established hierarchy includes locating any tool elements on one or more layers above the image elements.

9. The method as set forth in claim 8, wherein the pre-established hierarchy includes locating any photograph elements on one or more lowermost layers.

10. The method as set forth in claim 1, further including the step of allowing the user to directly access and cause to be displayed, in accordance with the pre-established hierarchy, any particular menu element of a plurality of different menu elements.

11. The method as set forth in claim 1, further including the step of conditioning, prior to display, an image element in order to further minimize interference between the elements, wherein said conditioning includes making an unimportant portion of the image element at least semi-transparent.

12. A method for simultaneously displaying two or more elements on a GPS device, the method comprising the steps of:
(a) allowing a user to select the two or more elements for display;
(b) ordering the elements hierarchically on one or more layers in accordance with a pre-established hierarchy for minimizing interference between the elements, wherein the hierarchy includes—
locating any control elements in a topmost layer and locating any image elements in one or more lower layers,
locating any tool elements on one or more layers above the image elements, and
locating any photograph elements on one or more lowermost layers; and
(c) displaying the hierarchically ordered elements simultaneously.

13. The method as set forth in claim 12, wherein at least one of the elements is an image element selected from the group consisting of: aerial photographs, perspective photographs, topographical maps, satellite images, weather images, and Doppler radar images.

14. The method as set forth in claim 12, wherein at least one of the elements is an information element selected from the group consisting of: geo-referenced waypoints, geo-referenced trails, geo-referenced paths, and geo-referenced symbols.

15. The method as set forth in claim 12, wherein at least one of the elements is a tool element selected from the group consisting of: virtual compasses, direction finders, direction indicators, clocks, and timers.

16. The method as set forth in claim 12, wherein at least one of the elements is a control element selected from the group consisting of: virtual buttons, virtual switches, symbols, and menus.

17. The method as set forth in claim 12, wherein at least one of the elements is dynamic, and wherein the at least one dynamic element functions without substantial interference from any other simultaneously displayed element.

18. The method as set forth in claim 12, further including the step of allowing the user to directly access and cause to be displayed, in accordance with the pre-established hierarchy, any particular menu element of a plurality of different menu elements.

19. The method as set forth in claim 12, further including the step of conditioning, prior to display, an image element in order to further minimize interference between the elements, wherein said conditioning includes making an unimportant portion of the image element at least semi-transparent.

20. A method for simultaneously displaying two or more elements on a GPS device, the method comprising the steps of:
(a) allowing a user to select the two or more elements for display;
(b) ordering the elements hierarchically on one or more layers in accordance with a pre-established hierarchy for minimizing interference between the elements;
(c) conditioning an image element by making an unimportant portion of the image element at least semi-transparent; and
(d) displaying the hierarchically ordered and conditioned elements simultaneously.

21. The method as set forth in claim 20, wherein at least one of the elements is an image element selected from the group consisting of: aerial photographs, perspective photographs, topographical maps, satellite images, weather images, and Doppler radar images.

22. The method as set forth in claim 20, wherein at least one of the elements is an information element selected from the group consisting of: geo-referenced waypoints, geo-referenced trails, geo-referenced paths, and geo-referenced symbols.

23. The method as set forth in claim 20, wherein at least one of the elements is a tool element selected from the group consisting of: virtual compasses, direction finders, direction indicators, clocks, and timers.

24. The method as set forth in claim 20, wherein at least one of the elements is a control element selected from the group consisting of: virtual buttons, virtual switches, symbols, and menus.

25. The method as set forth in claim 20, wherein at least one of the elements is dynamic, wherein the at least one dynamic element functions without substantial interference from any other simultaneously displayed element.

26. The method as set forth in claim 20, further including the step of allowing the user to directly access and cause to be displayed, in accordance with the pre-established hierarchy, any particular menu element of a plurality of different menu elements.
